(19) United States
(12) Patent Application Publication
(10) Pub. No.: US 2024/0192092 A1
(43) Pub. Date: Jun. 13, 2024

(54) DEFORMABLE WHEEL FOR OVERRUNABLE TEST VEHICLE

(71) Applicant: Humanetics Austria GmbH, Linz (AT)

(72) Inventor: Lukas Proprentner, Linz (AT)

(73) Assignee: Humanetics Austria GmbH, Linz (AT)

(21) Appl. No.: 18/569,482

(22) PCT Filed: Jun. 24, 2022
(86) PCT No.: PCT/IB2022/055903

§ 371 Date: Dec. 12, 2023

Related U.S. Application Data
(60) Provisional application No. 63/214,933, filed on Jun. 25, 2021.

(51) Int. Cl. G01M 17/007; B60B 9/26

(52) U.S. Cl. CPC G01M 17/0078; B60B 9/26

(57) ABSTRACT

The present teachings generally provide for an overrunable test vehicle for use with a soft target. The overrunable test vehicle comprises a chassis defining a cavity and having an external mounting area for receiving the soft target, at least one non-driven wheel supported by the chassis, at least one drive mechanism supported by the chassis having an electric motor and a drive wheel operatively connected with the electric motor, and a control system disposed within the cavity and coupled to the electric motor for sending and receiving information. The non-driven wheel is deformable with the non-driven wheel having an initial state with a first height and a deformed state with a second height where the second height is less than the first height. The non-driven wheel is configured to enter the deformed state when a threshold force is applied, and transition towards the initial state when the force is lessened.

### TECHNICAL FIELD

This Application generally relates to test vehicles used in relation to Advanced Crash Avoidance, particularly overrunable test vehicles (OTV).

### BACKGROUND

With the rise of Advanced Driver Assistant Systems (ADAS) being developed and tested, the need for testing equipment which reduce risk to testing members, while being able to sustain potentially damaging impacts and scenarios has drastically increased. A paramount tool in testing the developing crash avoidance technologies is the use of mobile and controllable platforms. The mobile platforms are adapted to hold a simulated target objects such as an automobile, truck, pedestrian, bicycle, or similar. The simulated target is typically made of a material which will not damage the vehicle equipped with the ADAS, such as foam, cardboard, or any other soft material.

During testing, different soft targets may be employed in different scenarios to obtain different data from the ADAS systems. Depending on the soft target, different mobile test platforms may be used in order to better simulate the particular test scenario to test certain features of the crash avoidance technologies integrated into passenger vehicles.

### SUMMARY

The present teachings generally provide for an overrunable test vehicle for use with a soft target. The overrunable test vehicle comprises a chassis defining a cavity and having an external mounting area for receiving the soft target, at least one non-driven wheel supported by the chassis, at least one drive mechanism supported by the chassis having an electric motor and a drive wheel operatively connected with the electric motor, and a control system disposed within the cavity and coupled to the electric motor for sending and receiving information. The non-driven wheel is deformable with the non-driven wheel having an initial state with a first height and a deformed state with a second height where the second height is less than the first height, and wherein the non-driven wheel is configured to enter the deformed state when a threshold force is applied to the chassis to reduce the overall height of the chassis, and transition towards the initial state when the force is lessened.

### BRIEF DESCRIPTION OF THE DRAWINGS

FIG. 1 illustrates a perspective view of an overrunable test vehicle (OTV) supporting a soft target in accordance with the invention.

FIG. 2 illustrates a perspective cross-sectional view of the OTV.

FIG. 3 illustrates a side view of the OTV.

FIG. 4 illustrates a fragmented bottom view of the OTV with an exposed control portion.

FIG. 5 illustrates a fragmented cross-sectional side view of a drivetrain and suspension system.

FIG. 6 is a fragmented cross-sectional side view of a deformable non-driven wheel.

FIG. 7A is a perspective view of one configuration of a deformable non-driven wheel.

FIG. 7B is a perspective view of another configuration of a deformable non-driven wheel.

FIG. 7C is a perspective view of another configuration of a deformable non-driven wheel.

FIG. 8A illustrates a schematic side view of a deformable non-driven wheel in an undeformed state and a deformed state.

FIG. 8B is a perspective schematic view of a deformable non-driven wheel in an undeformed state and a deformed state.

FIG. 9A is a bottom perspective view of a deformable non-driven wheel in an undeformed state.

FIG. 9B is a bottom perspective view of a deformable non-driven wheel in a deformed state.

FIG. 10 is a chart of example test data relating to deforming a non-driven wheel.

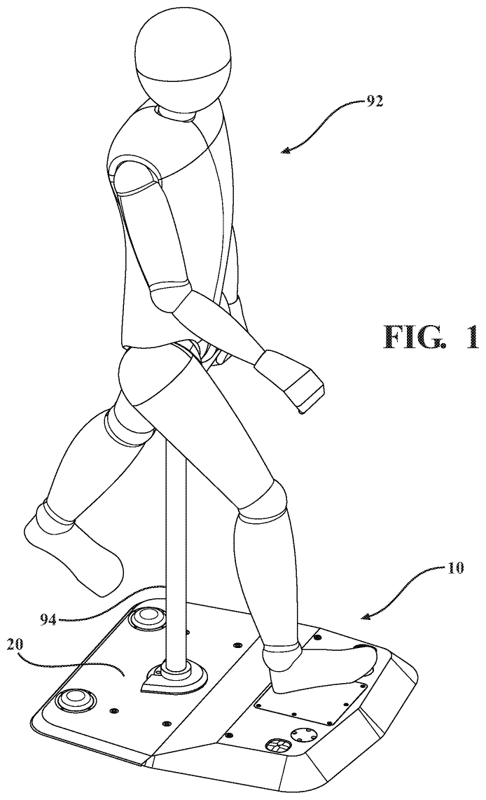

### DETAILED DESCRIPTION

The various versions of the present disclosure will be described in detail with reference to the accompanying drawings. Wherever possible, the same reference numbers will be used throughout the drawings to refer to the same or corresponding parts. References made to particular examples and implementations are for illustrative purposes and are not intended to limit the scope of the present disclosure.

The present teachings relate to a test vehicle used in advanced crash avoidance technologies. The test vehicle 10 may function as a mobile and controllable platform for holding a simulated target object 92 such as an automobile, truck, pedestrian, bicycle, or similar. The test vehicle may be an overrunable test vehicle (herein OTV). During crash avoidance testing, the OTV may be subjected to rigorous conditions, including be run over by a vehicle with advanced crash avoidance technologies. The OTV 10 may be configured to withstand the weight of an automobile. For example, the OTV 10 may be able to withstand a passenger car of 3.5 tons. In some examples, the OTV may be able to withstand 4 tons per wheel. The OTV 10 may be configured to hold an automobile consistent with M1 of the EU vehicle definitions category (https://www.transportpolicy.net/standard/eu-vehicle-definitions/). The OTV 10 may be configured to move a soft target with a weight of 5 kilograms (kg) or more, 10 kg or more, 20 kg or more, 50 kg or more, or even 75 kg or more. The OTV 10 may be able to move the one or more soft targets to a speed of at least 5 kilometers per hour (kph), at least 10 kph, or even at least 20 kph. In some examples, the OTV 10 may have a different top speed loaded than when the OTV 10 is free from a soft target. In some examples, the OTV may have a top speed of between 5 kph and 20 kph when loaded with a soft target weighing between 10 kg and 50 kg or more.

The OTV 10 includes a frame 12. The frame 12 (also referred to as chassis) may function as the base structure of the test vehicle. The frame may be made of steel, composite material, aluminum, plastic, or a combination thereof. In some examples, the frame may be a unitary component. In other examples, the frame may be made of two or more modular components. For example and described further below, the control section 14 of the chassis 12 may be made from a single block of machined aluminum and connected with the carrier section 16. The frame 12 may be divided into several sections corresponding with certain features of the OTV. The sections of the frame/chassis 12 may be divided into separate compartments to house the different systems and components of the OTV 10. The chassis 12 of the OTV 10 may have a small footprint designed to carry a pedestrian soft target. The chassis 12 may have a generally geometric shape. For example, the chassis 12 may have a diamond design. Other shapes, such as rectangular, square, circular, triangular, polygonal or the like are contemplated. The chassis 12 may have an overall length of 2000 millimeters or less. In some examples, the frame has an overall length of 1000 millimeters or less, or even 800 millimeters or less. The OTV 10 may have a varying thickness (described further below) ranging between 10 millimeters and 200 millimeters. In some examples, the thickness may be between 25 millimeters and 75 millimeters. As provided for below, the frame 12 of the OTV may be divided into two or more sections with each section having a different thickness.

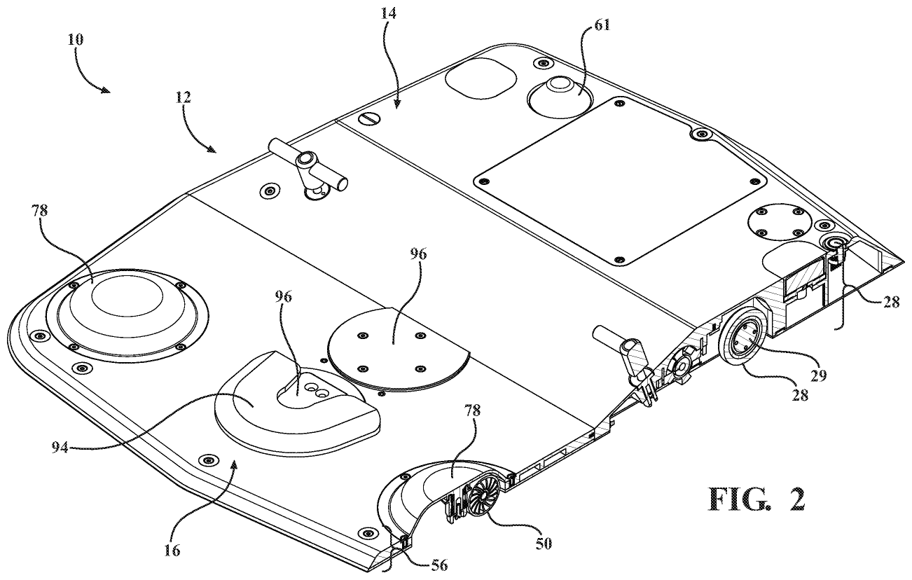

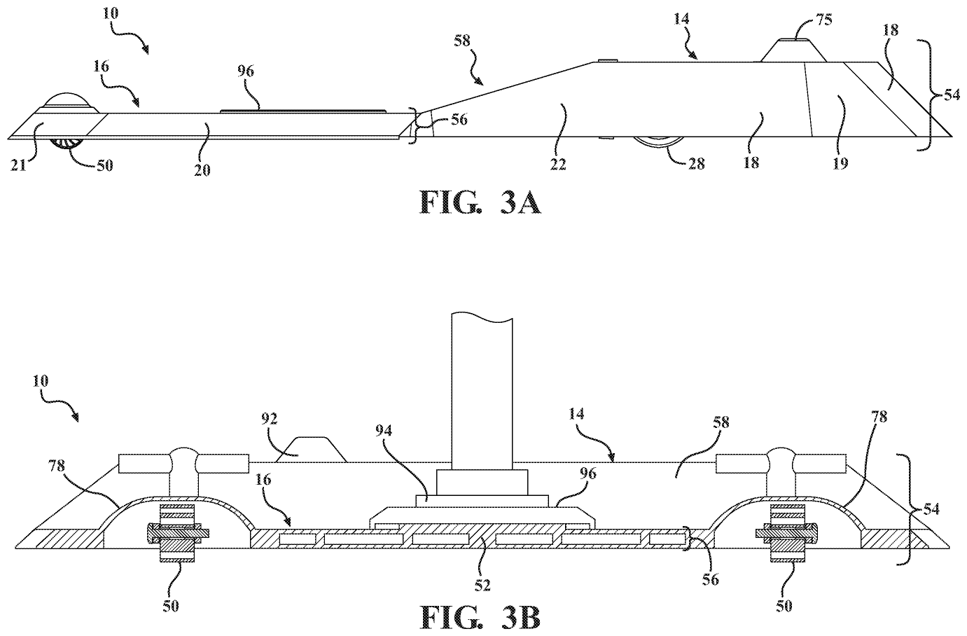

The frame 12 of the OTV 10 includes one or more sections. The sections 14, 16, may function to separate structural elements, mechanical systems, electrical systems, power systems, sensors, wheels, braking systems, steering systems, or a combination thereof from each other. Each section may include one or more corresponding compartment. Each compartment may be sealed or unsealed. The compartments may be watertight. The frame 12 may be divided into a plurality of compartments. In some examples, the OTV 10 is divided into at least two sections which are a control section 14 having a first thickness and profile height, and a carrier section 16 (also known as a target section) having a shorter, sleeker thickness and profile height. The control section 14 of the OTV may house at least a portion of the control system 80 and drivetrains 23 of the OTV 10. The carrier section 16 may hold the soft target mounting area 96 for connecting the soft target mount 94 to the OTV 10. An example mounting position for the soft target mount 94 can be seen in FIGS. 2 and 3A-3B. Once a soft target 92 is attached with the soft target mount, anchors may be used to further secure the soft target to the carrier section 16.

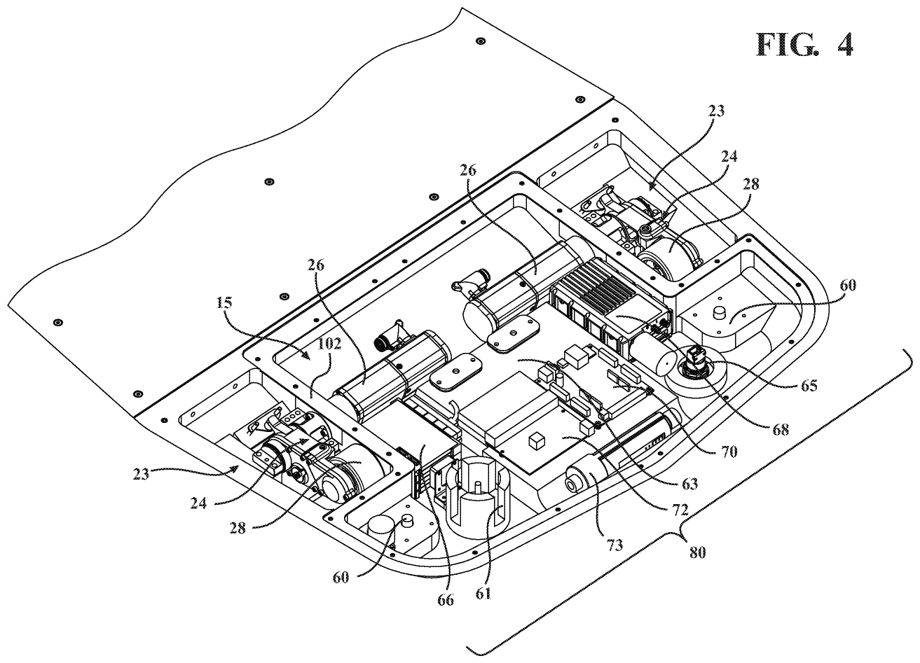

As seen in FIGS. 3A, 3B and 4, the control section 14 of the OTV 10 may be configured to carry the control system 80 and the drivetrain 23 of the OTV 10. The control section 14 may be coupled to a control system 80, one or more propulsion systems (e.g., one or more drivetrains 23), one or more batteries, a plurality of sensors, a plurality of antennas, or a combination thereof. The control section 14 may be taller than the carrier section 16. In some cases, the control section 14 may have a height that is at least 50% larger, 80% larger, 100% larger, 300% larger, or even 500% larger. In one example, as seen in FIG. 3, the control section 14 is shown with a height 54 approximately triple (300% larger) the height 56 of the carrier section 16.

Turning to the other end of the OTV 10, the carrier section 16 is configured to hold the soft target mount pad for connecting the soft target mount 94. The carrier section 16 is exceptionally thin to provide a minimal radar cross section (RCS). A minimal RCS may function to allow a vehicle 90 with ADAS being tested to identify the soft target 92 without necessarily picking up the RCS of the OTV 10, reducing radar interference of the ADAS of the vehicle 90 from the OTV 10. The carrier section has a thickness 56, as shown in FIGS. 2 and 3A-3B. The profile thickness 56 may be between 5 millimeters and 35 millimeters. In some examples, the carrier section 16 may be about 25 millimeters or less.

As can be seen best in FIGS. 3A and 3B, the carrier section 16 profile cross section height/thickness 56 (also referred to as profile height) is substantially thinner than the control section 14 profile thickness 54. The control section 14 may have a thickness of about 25 millimeters to 200 millimeters. In some examples, the control section 14 has a thickness 54 of about 75 millimeters or less. The OTV 10 is configured to minimize the radar cross section (RCS) such that the profile of the OTV 10 will not disrupt the radar signature of the soft target carried by the OTV 10. The OTV 10 may have any shape which reduces the radar cross section of the carrier. In some examples, the OTV 10 may have a relatively diamond shape. In other examples, the OTV 10 may be square, rhombic, circular, pentagonal, hexagonal, polygonal, or any shape which may reduce radar cross section. The shape, height, slope, and material selection all contribute to the RCS.

Turning to FIGS. 3A and 3B, the frame 12 may include a plurality of side walls 18, 20, 22. The sidewalls 18, 20, 22 may be sloped to allow for ingress or egress of a vehicle while performing a test. The sidewalls 18, 20, 22 may have different or varying slopes around the perimeter of the OTV 10. The sidewalls 18, 20, 22 may have the same slope. The sidewalls 18, 20, 22 may have a height which corresponds with the section of the frame 12 the sidewalls 18, 20, 22 are connect with. In some examples, each of the sidewalls 18, 20, 22 may be configured as ramps. The plurality of sidewalls 18, 20, 22 may function to assist a vehicle 90 with Advanced Driver Assistant Systems (ADAS) technology run over the test vehicle 10 by allowing the tires of vehicle 90 to climb over the test vehicle 10. Each of the sidewalls 18, 20, 22 may be one or more, two or more, four or more, six or more, or even 10 or more sidewalls. In some examples, one or more of the sidewalls 18, 20, 22 may be permanently connected with the frame 12. In other examples, the sidewalls 18, 20, 22 may be removably connected with the frame 12. The plurality of sidewalls 18, 20, 22 may extend from the bottom plane of the OTV 10 to the top plane of the OTV 10, sloping upwards creating a ramp. A top portion of the plurality of sidewalls 18, 20, 22 may be flush and planar with the top portion of one or more of the OTV sections 14, 16, 58. A bottom portion of the plurality of sidewalls 18, 20, 22 may be flush and planar with the bottom portion of one or more of the OTV sections 14, 16, 58. The OTV 10 may include at least one sidewall 18, 20, 22 for each side or portion of the test vehicle 10 so that the test vehicle may be easily overrun on any side.

The sidewalls 18 of the control section 14 include corners 19 which are rounded and sloped to minimize radar cross section while allowing a vehicle to overrun the test vehicle during operation. The sidewalls 18 and corners 19 may be nonplanar, such as having an arched profile. The corners 19 may assist in transitioning the profile of the front of the OTV 10 with the profile of the side of the OTV 10 to maintain the desired radar cross section. The corners 19 may have a different height, slope, profile, or combination thereof. The sidewalls 19 of the control section 14 along with corners 19 contribute to the profile of the OTV 10 that is partially angular and partially rounded and/or arched, reducing the radar cross section so that during testing, a vehicle with ADAS registers the radar cross section of the soft target 92 riding on the OTV 10 while minimizing the radar cross section of the OTV 10.

Similar to the control section 14, the sidewalls 20 of the carrier section 16 includes corners 21 with a shorter and thinner profile matching the sidewalls 20. On the distal end of the carrier section 16, sidewall 20 extends between corners 21. The sidewalls 20 and the corners 21 have a slope and a height which minimize the radar cross section of the carrier section 16 while allowing the OTV 10 to be overrun during a test. The sidewalls 20 of the carrier section 16 along with corners 21 contribute to the profile of the OTV 10 that is partially angular and partially rounded and/or arched, reducing the radar cross section so that during testing, a vehicle with ADAS registers the radar cross section of the soft target 92 riding on the OTV 10 while minimizing the radar cross section of the OTV 10.

As can be seen in FIG. 3A, a first set of sidewalls 18 associated with the control section 14 of the OTV 10 has a first profile height 54 and a second set of sidewalls 20 associated with the carrier section 16 of the frame 12 has a second profile height 56. In some examples, the first sidewalls 18 and the second sidewalls 20 have the same slope despite the difference in height. In other examples, the first sidewalls 18 and the second sidewalls 20 have different slopes. In some examples, the sidewalls 18 and 20 may be rounded and/or arched. A transition sidewall 22 along the transition section 58 having a varying profile is used to transition between the height difference between the control section 14 and the carrier section 16. The transition sidewall 22 may have the same pitched slope as the first sidewall 18, the second sidewall 20, a varying slope between the first sidewalls 18 and second sidewalls 20, or a combination thereof. In some examples, the transition sidewall 22 may be rounded and/or arched. In some examples, the sidewalls 18, 20, 22 may be removably connected with the frame 12. Similar to the control section 14 and the carrier section 16, the transition section 58 and corresponding sidewalls 22 contribute to the profile of the OTV 10 that is partially angular and partially rounded, reducing the radar cross section so that during testing, a vehicle with ADAS registers the radar cross section of the soft target 92 riding on the OTV 10 while minimizing the radar cross section of the OTV 10.

As mentioned above, the control section 14 houses at least a portion of the control system 80, one or more drivetrains 23, one or more batteries, a plurality of sensors, a plurality of antennas, or a combination thereof within the control section cavity 15. The cavity 15 of the control section 14 is a hollowed space where a portion of the control system 80, drivetrains 23, batteries, one or more of the plurality of sensors, one or more of the plurality of antennas, or a combination thereof are mounted and/or stored. The cavity 15 may be divided into compartments (as mentioned above).

The control system 80 is housed within the control section 14 of the OTV 10. The control system may include a plurality of controllers, a plurality of sensors, or both working in unison and/or independently. As can best be seen in FIGS. 4, The control system 80 may include a control board, a safety controller 66, inertial measurement unit 68, steering controller 70, communications controller 72, an onboard Wi-Fi module 73, Wi-Fi antenna 60, GPS antennas 61, maintenance port 65, motors 26, or a combination thereof. The control system 80 may also include a plurality of sensors such as a ground speed sensor, an inertial sensor, a force sensor, the like, or a combination thereof. The control system 80 may receive data from the plurality of sensors and controllers (e.g., ground speed sensor, GPS antenna 61, motor 26, external controllers). The control system 80 may calculate the optimum acceleration parameters, deceleration parameters, or both based on the data received from the plurality of sensors. The control system 80 may utilize an algorithm which optimizes acceleration and deceleration without causing unnecessary or undesirable conditions such as a wheel slip condition.

The OTV 10 includes one or more batteries disposed within battery housing 63. The one or more batteries may function to provide power to test vehicle 10. The test vehicle 10 may have one or more, two or more, three or more, or even a plurality of batteries. The one or more batteries may be removably connected with the test vehicle 10. The one or more batteries are connected with a power controller. In some examples, the one or more batteries are integrated with the power controller. In some examples, there is one power controller for each battery. In other examples, the power controller and the one or more batteries are separate. The one or more batteries may provide the OTV 10 with one or more hours, two or more hours, three or more hours, or even four or more hours of continuous operation. The one or more batteries may swappable so that a user may quickly change to a charged battery to resume testing. The one or more batteries may be located in one or more compartments of the OTV 10. The one or more batteries may power the motors 26 to move the OTV 10 to 12 or more kph. The one or more batteries may power the motors 26 to provide constant speed for an extended period of time while testing.

The OTV 10 includes one or more motors 26 located within the control section 14. The one or more motors 26 may function to provide propulsion to the OTV 10. The one or more motors may function to assist in slowing down or stopping the OTV 10. In the example shown, the one or more motors 26 are electric motors. As seen in FIG. 4, the OTV 10 includes two motors 26. Each motor 26 may include a motor housing and an output shaft. Each of the one or more motors 26 may be independently powered and controlled. The one or more motors 26 may be controlled separately by the control system 80. In other examples, each motor 26 includes an integrated motor controller. The integrated motor controller may function to determine and communicate the one or more motor parameters between the motor 26 and the control system 80. The one or more motors 26 may function as a steering system. For example, as shown in FIG. 4, the motors 26 may be operatively connected with the transaxle 24 and control the steering of the OTV 10 by increasing and decreasing power output and direction of rotation of the drive wheels 28 through each transaxle 24. The placement of the transaxles 24 allow the OTV 10 to turn on the spot. When the OTV 10 is carrying a soft target 92, the soft target 92 may have a turning radius of approximately 300 millimeters. The one or more motors 26 may be a part of the drivetrain 23 and connected with the transaxle, a suspension system, one or more power supplies (i.e., batteries), one or more drive wheels 28, or a combination thereof.

The one or more motors 26 power the drivetrain 23. The drivetrain 23 may include a transaxle 24. The transaxle 24 may function to translate rotational movement from the output of each motor 26 into rotational movement of one or more drive wheels 28 at a location away from the output shaft of the motors 26. In some examples, the one or more drive wheels 28 are directly connected to the output of the motors 26. In some examples, the transaxle may be a chain drive connecting the output of the motors 26 to a drive wheel 28. The chain drive may function to transfer rotational movement from an output shaft of the motor 26 to power the drive wheel 28. The chain drive may include at least one chain, belt, band, the like, or a combination thereof. Connected with the chain drive may be a tensioner 36.

The OTV 10 includes at least one drive wheel 28 per transaxle 24. The drive wheels 28 may function to move the OTV 10 over a surface. The OTV 10 may include two or more, three or more, or even four or more drive wheels 28. For example, as seen in FIG. 4, the frame 12 houses two drive wheels 28, one on each transaxle 24. Each drive wheel 28 rotates about a drive axle defining an axis.

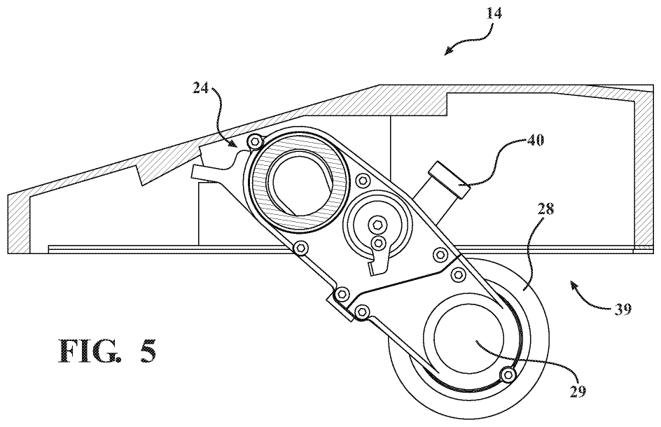

The transaxle 24 is integrated with and is a part of a suspension system 39. The suspension system 39 may function to allow relative movement between the frame 12 and the discrepancies of the road as contacted by the drive wheels 28, provide damping as the OTV 10 maneuvers over a surface. The suspension system 39 comprises the drivetrain 23 and one or more dampers 40, with at least a portion of the drivetrain 23 and the damper 40 each interacting with the frame 12 of the OTV 10, directly or indirectly. The suspension system 39 and transaxle 24 can be seen in FIG. 5. The suspension system 39 may function to absorb some of the shock of being run over during a test, minimizing damage sustained to the OTV 10. The suspension system 39 may include one or more absorbers and/or dampers 40. The one or more absorbers 40 may be shocks, struts, springs, or any other suitable damping device. The one or more suspension systems 39 may be operatively connected with one or more drive wheels 28, one or more motors 26, the frame 12, or a combination thereof. For example, a first damper 40 is connected with a first transaxle 24, and a second damper 40 is connected with a second transaxle 24 so that when the OTV 10 rides over a change in the driving surface, the drive wheels 28 remain planted on the driving surface. When the OTV 10 is run over, the drive wheel 28 and the drive axle 29 are configured to move a suspension height when a force is applied to the chassis 12 to reduce the overall height of the chassis 12. In some examples, the suspension system 39 is configured to be movable into the frame 12 when the OTV 10 is ran over, allowing the outer surface 99 and the frame 12 to take the impact of being driven over, such that the bottom surface of the frame 12 contacts the ground to take the load of the overrun.

Each of the drive wheels 28 may include a tire wrapped around its circumference. In some examples, the drive wheel may integrate the tire such that the wheel and the tire are unitary. The tires may function to provide traction on a surface. The tires may be made natural rubber, synthetic rubber, plastic, fabric, steel, polymers, or a combination thereof. The tires may be inflatable. The tires may be an airless design. The tires may be solid. The tires may be deformable. The tires may be a disposable item that may be replaced when worn out.

The drivetrain 23 may be configured to accelerate and decelerate the OTV 10. The OTV may be capable of speeds of at least 5 kph, at least 10 kph, or even at least 20 kph. The speed at which the OTV 10 may travel is dependent on the load carried by the OTV 10, which, in most cases, will be a soft target 92. The drivetrain 23 may be configured to accelerate the OTV 10 at a rate 0.1 m/s² and 5.0 m/s² or more. The drivetrain 23 may be configured to assist the OTV 10 in decelerating and stopping at a rate ranging between −0.1 m/s² and −5.0 m/s² or more. In some examples, the rate of acceleration and deceleration is weight dependent. In one example, the OTV 10 is capable of accelerating at a rate of 2.0 m/s² and decelerate at a rate of −2.0 m/s² with a payload of 10 kg. Acceleration and deceleration are affected by the weight of the payload on the OTV 10 resulting in slower acceleration and deceleration when the weight of the soft target 92 is increased.

The control system 80 is connected with the one or more motors 26, the one or more motor controllers, or both. The control system 80 may include the one or more motors, one or more motor controllers, or both. The control system 80 may send messages and/or commands relating to one or more motor parameters to the motor controller which controls the actuation of the motor 26. Motor parameters are one or more outputs of the motor which can be commanded by the motor controller, the control system 80, or both. The motor parameters may include a motor speed, a motor torque, or both. The one or more motor parameters may be executed by delivering a specific electric current to the one or more motors 26. The motor controller may communicate with the control system 80 through a controller area network (CAN) which sends data through the control system 80, controlling the operation of the OTV 10. The control system 80 may function to control the amount of braking force used by the OTV 10 to decelerate and stop. The control system 80 may work in conjunction with the motor controller to control the one or more motor parameters to slow down or stop the OTV 10 at a particular deceleration.

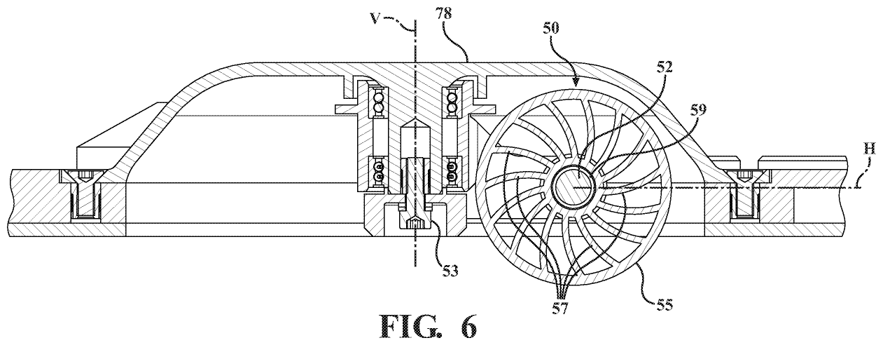

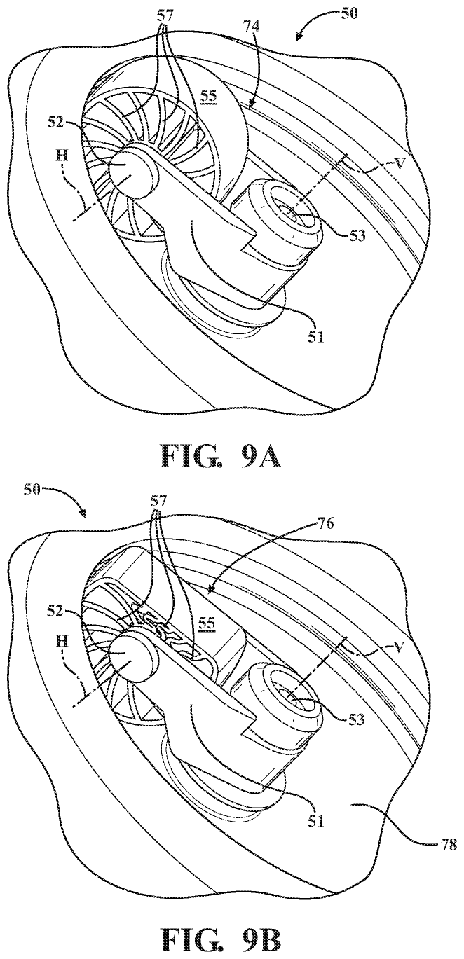

Referring to FIGS. 6 and 9A-9B, FIG. 6 is a partial cross-sectional view of the carrier section 16. The carrier section 16 includes one or more non-driven wheels 50. In this example, the OTV 10 may include two non-driven wheels configured as caster wheels 50. In some examples the OTV 10 may have one non-driven wheel. In other examples, the OTV 10 may have a plurality of non-driven wheels 50. The carrier section 16 provides for openings which allow the non-driven wheels 50 to protrude through and contact a surface. The non-driven wheels 50 are slightly taller than the profile 56 of the carrier section 16 so that the OTV 10 can be moved without the carrier section 16 contacting the ground. Each non-driven wheel may have a diameter of 10 millimeters or more, 20 millimeters or more, 30 millimeters or more, or even 50 millimeters or more. In some examples, the non-driven wheels 50 may provide 5 millimeters or more, 10 millimeters or more, or even 20 millimeters or more ground clearance for the OTV 10. As can be seen in FIGS. 2 and 6, the non-driven wheels may be enclosed by a cover 78 removably secured to the frame 12 on the outer surface.

The non-driven wheels 50 may be connected with the carrier section 16 through a fork 51. Each fork 51 includes a wheel axle 52 disposed through the center of each non-driven wheel 50, defining a horizontal wheel axis (H). Each fork 51 is connected with a vertical axle 53, which is connected with a portion of the carrier section 16, such as the wheel cover 78. The vertical axle 53 may be a fastener that connects the non-driven wheel 50 and the fork 51 to the OTV 10. The vertical axle 53 defines a vertical axis (V). The vertical axis V is perpendicular to the horizontal axis H, thereby creating a non-driven wheel 50 that operates as a caster wheel by rotation about two axes. For example, in FIG. 6, the vertical axle 53 is connected with the cover 78. The non-driven wheel 50 is held by a fork 51 which is connected with the vertical axle 53 (FIGS. 9A and 9B). Each fork 51 is connected with the vertical axle 53 are configured to freely rotate around the vertical axis V of the vertical axle 53, changing the direction of the non-driven wheel 50 when the fork 51 is rotated. The non-driven wheel 50 are constrained in from moving in a vertical degree of freedom by the wheel axle 52 and the vertical axle 53. The wheel axle 52 and vertical axle 53 allow the non-driven wheel 50 to move in at least two degrees of freedom thereby defining the caster wheel. Similarly, the wheel axle 52 is disposed through the center of the non-driven wheel 50 and interfaces with a bushing 59. The bushing 59 may be a stationary bushing or a sliding bushing. It is further contemplated that the bushing 59 may be a bearing.

As can be seen in FIG. 6, the non-driven wheel 50 is configured as an airless deformable caster wheel 50. The non-driven wheels 50 are made from rubbers, synthetic rubbers, thermoplastics, or a combination thereof. The deformable non-driven wheels 50 are configured to absorb impact on at least a portion of the carrier section 16 from a vehicle when the OTV 10 is run over, compressing and deforming the deformable non-driven wheels 50 between the OTV10 and a driving plane. The non-driven wheels may be formed using any suitable methods. Some nonlimiting examples of production methods include injection molding and 3-D printing. In one nonlimiting example, the non-driven wheels 50 may be made of polyamide 12 (commonly referred to as Nylon 12) available as PA-12 from Hewlett Packard Enterprise at 11445 Compaq Center Drive West, Houston, Texas 77070. In another example, each of the deformable non-driven wheels 50 is made of nGen Flex material available from ColorFabb at Bremweg 75951 DK Belfeld, the Netherlands. In another non-limiting example, the deformable non-driven wheels 50 may be made from TPU Flex Hard filament, a durable elastomer based on polycaprolactone polyester, available from Extrudr FD3D GmbH at Klosterstraße 13, 6923 Lauterach, Austria. The non-driven wheels 50 may support an initial load of 80 or more, 100 or more, 200 or more, or even 400 or more newtons before deforming. The material, in combination with the design of the non-driven wheel 50, allows the non-driven wheel to deform when a substantial force is applied, such as when a car or truck over runs the OTV 10. The non-driven wheels 50 also have an elasticity to resume a normal shape after the over running vehicle has been removed from the OTV 10. Since the deformable non-driven wheels are deformable and elastic, resuming an initial shape 74 after being compressed into a deformed state 76, the carrier section 16 of the OTV does not require a suspension system. In some examples, when the OTV 10 is run over, the suspension height of the drive wheel 28 and drive axle 29 are at least equal to the second height of the non-driven wheel in the deformed state 76 to uniformly reduce the overall height of the chassis 12. The deformable non-driven wheels 50 allow for more space in the thin carrier section 16 since a suspension is not required in the carrier section 16 to absorb force, allowing the space to be repurposed, such as increasing protections to other components of the OTV 10.

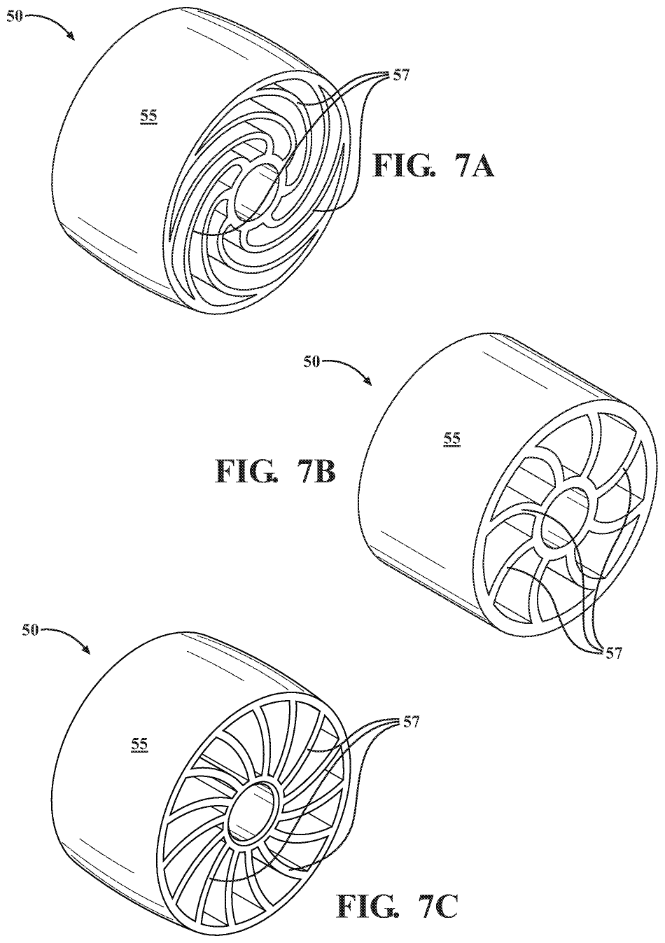

The non-driven wheels 50 each include a plurality of fins 57 extending from the center of the non-driven wheel 50 towards the outer surface of the non-driven wheel 50. Each of the plurality of fins 57 may have the same profile. Each of the plurality of fins 57 may have individual profiles. In the example shown in FIGS. 5, 7A-7B, and 9A-9B, each of the fins 57 has a curved profile. The plurality of fins 57 are arranged to transfer force from the contact surface 55 of the non-driven wheel 50 toward the wheel axle 52, without deflecting the wheel axle 52 or vertical axle 53. As seen in FIGS. 7A-7C and 9A-9B, the plurality of fins 57 have an arcuate and/or hooked shape.

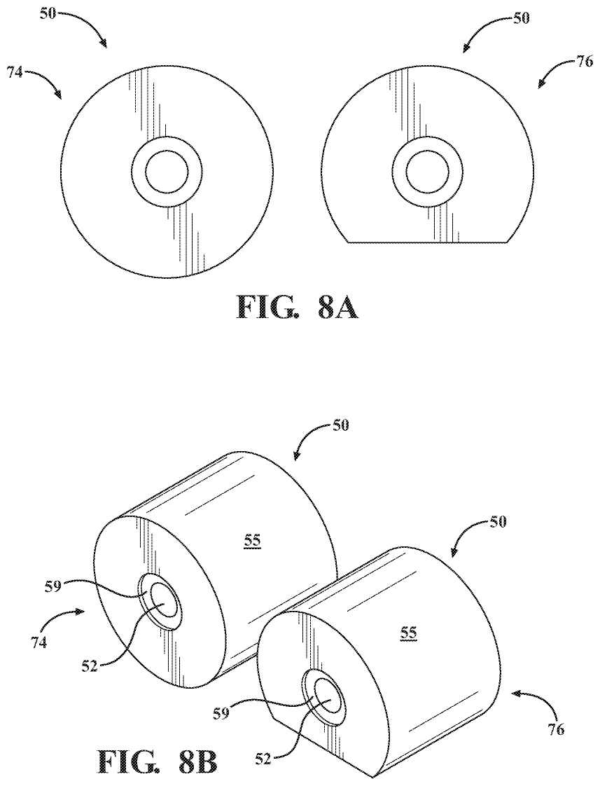

The non-driven wheels 50 may be configured to deform when the OTV 10 is ran over by a car or truck. The non-driven wheels 50 may be configured to deform from the contact surface with the ground to the axle 52 when a car or truck over runs the OTV. In some examples, the non-driven wheels 50 may deform 5 millimeters or more, 10 millimeters or more, or even 20 millimeters or more. In some examples, the non-driven wheels 50 may deform 10 percent or more, 20 percent or more, or even 40 percent or more of the diameter of the non-driven wheels 50. In some examples, such as shown in FIGS. 8A and 8B, the non-driven 50 may have a diameter of 30 millimeters in an initial state 74, and, upon applying a sufficient force (e.g., overrunning the OTV 10 with an automobile), compress the contact surface 55 and at least some of the plurality of fins 57 about 5 millimeters into the compressed/deformed state 76. When the non-driven wheels are compressed into the deformed state 76 during a vehicle overrun, the wheel axis 52 does not move in a vertical direction towards the chassis 12, but rather stays in the same plane as when the non-driven wheels 50 are in the initial state 74. In other examples, further and greater deformation is contemplated. The non-driven wheels 50 are resilient to repeated deformation and crash testing. In one nonlimiting example, the non-driven wheels 50 may be deformed 5 millimeters or more repeatedly during a day, allowing a user approximately thirty days of use before replacing the non-driven wheels 50.

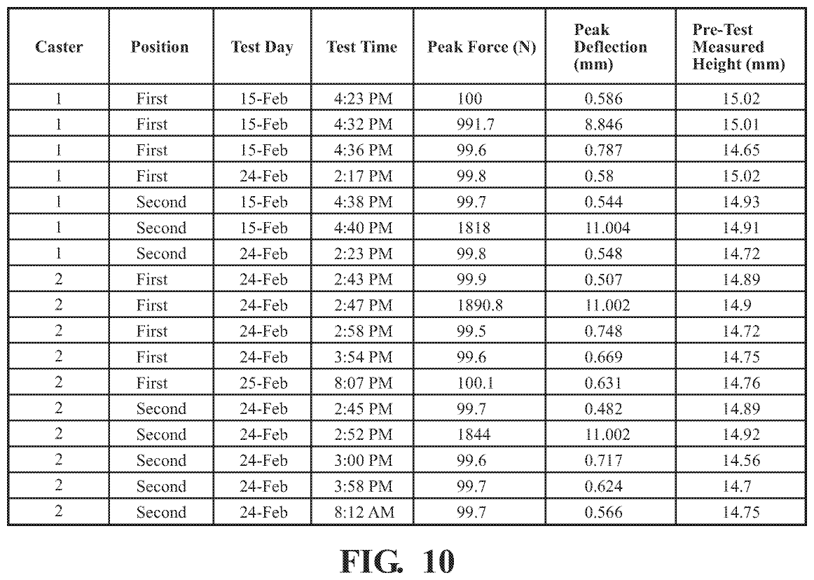

FIG. 10 illustrates an example data set relating to a quasi-static compression test that measures deformation of an example deformable non-driven wheel at different loads at varying elapsed times in a first position and a second position which is 90 degrees rotated from the first test position. The first test position and the second test position were subjected to various loads to simulate a normal load on the deformable non-driven wheels of the OTV 10 which is approximately 8-11 kilograms and an over-run load on the deformable non-driven wheels simulating a vehicle overrunning the OTV 10 by compressing the deformable non-driven wheels to approximately 8-12 millimeters. The amount of deformation is recorded and the recovery height (i.e., when the test non-driven wheel is free from compression) from deformation is measured after compression and before the next test. The elapsed time between each test is recorded and the height of the tested non-driven wheel is recorded without a compressing force applied to show the height before and after deformation and the time which has passed, showing the recovery rate of the material of the non-driven wheel. In some examples, an initial height may be a range of heights indicating that the deformable non-driven wheel to be expanded and is not experiencing a substantial deformable force. In some examples, the initial height may be within a range, such as between the overall height of the non-driven wheel before any deformation and 10% less than the overall height of the non-driven wheel before any deformation has occurred. In some examples, after the non-driven wheel has been deformed, the height range corresponding to the initial height may be 1% or more of a first measured height before compression. In other examples, after the non-driven wheel has been deformed, the heigh range corresponding to the initial height may be 10% or less of a first measured height before compression. In other examples, the height range corresponding to the initial height may be within 5% of a first measured height before compression and a second height measured after the compressing force is removed. In some examples, short term height recovery of the deformable non-driven wheel (approximately one hour) is recorded, and in at least one instance, long term height recovery of the non-driven wheel (approximately one day) is recorded.

Turning back to FIG. 10, when approximately 100 newtons is applied to the deformable non-driven wheel, deflection is between 0.5 millimeters and 0.8 millimeters in both the first test position and the second test position. In the test data presented in FIG. 10, the application of 90-100 newtons causes the non-driven wheel to deform slightly, replicating the amount of deformation that occurs during operation of the OTV 10.

During normal operation of the OTV 10, the non-driven wheels 50 will slightly deform under the weight of the OTV 10. The OTV 10 weighs approximately 25 kilograms along with, in some examples, a 15 kilogram payload (e.g., soft target 92). In some examples, the total weight of an OTV 10 is 40 kilograms. In the examples shown, the OTV 10 has four wheels so the wight of the loaded OTV 10 is divided by four for an approximate weight per wheel of 10 kilograms, which is substantially similar to 100 newtons per wheel. In some examples, since 100 newtons is applied to the non-driven wheel 50 during normal operation, a deformation of 0.8 millimeters or less of the total height of the non-driven wheel 50 holding the OTV without a soft target 92 may be considered to be the non-deformed initial state 74. The initial state 74 of the non-driven wheels corresponds to the weight of the OTV 10. Any additional weight added from connecting a soft target 92 onto the OTV 10 will cause the non-driven wheels 50 to deform slightly more, so in some examples, the non-driven wheels 50 may have an initial height with a deformation greater than 0.8 millimeters proportional to the additional weight of the soft target 92 added to the OTV 10.

In the example tests shown in FIG. 10, when a substantial compressing force (over 900 newtons) is applied to the deformable non-driven wheel, the deformable non-driven wheel is deformed. The tested non-driven wheels enter the deformed state when a threshold force is applied. The threshold force is a compressing force that deforms the non-driven wheel more than 10% of the initial height. In the present example shown in FIG. 10, the threshold force is greater than 100 newtons. In some examples, the tested non-driven wheel is deformed approximately 8.8 millimeters at about 990 newtons, and approximately 11 millimeters at about 1800 newtons. This simulates an overrun of the OTV 10. In the present example, when the test force corresponding to overrunning the OTV 10 is removed from the non-driven wheel being tested, the non-driven wheel recovers to a height of 0.4 millimeters or less of the initial height within a short time frame. The non-driven wheel may recover in approximately four minutes between tests. In some examples, the tested non-driven wheel has a recovery height of less than 0.02 millimeters between the initial height and the recovered height (shown as the pre-test measured height of the next test). In some examples, the non-driven wheel may recover within the range of the initial height in two minutes. In some examples, the deformable non-driven wheel recovers within 5% of the pre-tested height between 5 and 10 minutes. The height recovery may be quicker from the deformed state to the initial state quicker than 5 minutes.

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

1. An overrunable test vehicle for use with a soft target, the overrunable test vehicle comprising:
a chassis defining a cavity and having an external mounting area for receiving the soft target;
at least one non-driven wheel supported by the chassis;
at least one drive mechanism supported by the chassis having an electric motor and a drive wheel operatively connected with the electric motor; and
a control system disposed within the cavity and coupled to the electric motor for sending and receiving information;
wherein the non-driven wheel is deformable with the non-driven wheel having an initial state with a first height and a deformed state with a second height where the second height is less than the first height, and wherein the non-driven wheel is configured to enter the deformed state when a threshold force is applied to the chassis to reduce an overall height of the chassis, and transition towards the initial state when the force is lessened.

2. The overrunable test vehicle of claim 1, wherein the threshold force is at least 100 newtons applied to the chassis.

3. The overrunable test vehicle of claim 1, wherein the non-driven wheel enters the deformed state from the initial state when the first height is reduced by 0.5 millimeters or more.

4. The overrunable test vehicle of claim 3, wherein the non-driven wheel returns to the initial state when the height of the non-driven wheel has a height that is 5 percent or less of the first height.

5. The overrunable test vehicle of claim 1, wherein the non-driven wheel enters the deformed state when at least 100 newtons of force is applied and subsequently transitions to the initial state when less than 100 newtons of force is applied.

6. The overrunable test vehicle of claim 1, wherein the non-driven wheel includes a plurality of fins.

7. The overrunable test vehicle of claim 6, wherein each of the plurality of fins has a curved profile.

8. The overrunable test vehicle of claim 1, wherein the non-driven wheel absorbs impact between the chassis and a driving surface when a force is applied to the chassis towards the driving surface to reduce the overall height of the chassis.

9. The overrunable test vehicle of claim 1, further including a wheel axle supported by the chassis, and wherein the non-driven wheel is connected to the wheel axle with the wheel axle remaining in the same plane relative to the chassis when a force is applied to the chassis.

10. The overrunable test vehicle of claim 9, wherein the wheel axle defines a wheel axis, and wherein the non-driven wheel is rotatably coupled to the chassis through the wheel axis.

11. The overrunable test vehicle of claim 10, further including a vertical axle rotatably mounted to the chassis about a vertical axis with the non-driven wheel rotatably connected to the chassis through the vertical axle.

12. The overrunable test vehicle of claim 11, wherein the wheel axis is perpendicular to the vertical axle to allow the non-driven wheel to rotate in two degrees of freedom.

13. The overrunable test vehicle of claim 11, further including a fork mounted to the vertical axle and supporting the wheel axle to interconnect the vertical and wheel axles and support the non-driven wheel on the chassis.

14. The overrunable test vehicle of claim 1, wherein the non-driven wheel returns to the initial state from the deformed state in at least four minutes from removal of the threshold force.

15. The overrunable test vehicle of claim 1, wherein the chassis includes a control section and a carrier section with the control section having a profile height, and the carrier section having a profile height different than the profile height of the control section.

16. The overrunable test vehicle of claim 15, wherein the profile height of control section is at least 30 percent larger than the profile height of the carrier section.

17. The overrunable test vehicle of claim 1, further including a drive axle connected to the motor with the drive wheel connected to the drive axle.

18. The overrunable test vehicle of claim 17, further including a suspension operatively coupled to the drive wheel, wherein the drive wheel and the drive axle are configured to move a suspension height when a force is applied to the chassis to reduce the overall height of the chassis.

19. The overrunable test vehicle of claim 18, wherein the suspension height of the drive wheel and drive axle are at least equal to the second height of the non-driven wheel in the deformed state to uniformly reduce the overall height of the chassis.
